(19) United States
(12) Patent Application Publication
(10) Pub. No.: US 2008/0289610 A1
(43) Pub. Date: Nov. 27, 2008

(54) Pulse Supercharger in the Intake Tract of an Internal Combustion Engine

(75) Inventors: Thanh-Hung Nguyen-Schaefer, Asperg (DE); Johannes Meiwes, Markgroeningen (DE); Michael Baeuerle, Ditzingen-Heimerdingen (DE); Udo Sieber, Bietigheim (DE); Ralph Engelberg, Ditzingen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/662,294

(22) PCT Filed: May 3, 2005
(86) PCT No.: PCT/EP05/52027

§ 371 Date: Aug. 4, 2008

(30) Foreign Application Priority Data
Sep. 13, 2004 (DE) 10 2004 044 140.5

(51) Int. Cl. F02B 33/00

(52) U.S. Cl. 123/559.1

(57) ABSTRACT

A pulse supercharger for internal combustion engines, in which the pulse supercharger is situated in a charge air duct. The flow cross-section of the charge air duct for a charge air flow is opened or closed via the pulse supercharger. The pulse supercharger includes two synchronously operatable rotary slide elements.

### FIELD OF THE INVENTION

The present invention concerns and relates to a pulse supercharger in the intake tract of an internal combustion engine.

### BACKGROUND INFORMATION

To improve the cylinder charge with combustion air, superchargers are used in internal combustion engines. The superchargers may be designed as exhaust gas turbochargers or as pressure wave superchargers and increase the pressure level in the intake tract of an internal combustion engine to achieve a higher volumetric efficiency of the cylinders when the intake valves of the engine are open. At low speeds of the internal combustion engines, the “turbo lag” occurs in exhaust gas turbochargers because the mechanical power transmitted from the turbine wheel to the compressor rotor of the exhaust gas turbocharger is no longer sufficient for increasing the pressure in the intake tract of the internal combustion engine due to the low exhaust gas volume flow.

In exhaust gas turbochargers used in internal combustion engines, whether self-igniting or externally ignited internal combustion engines, the above-mentioned turbo lag occurs in the lower speed range of the internal combustion engine. In this operating state of an internal combustion engine, the exhaust gas volume flow produced by the internal combustion engine is insufficient for driving the compressor rotor of the exhaust gas turbocharger at a speed that might result in a significant increase in pressure in the intake tract of the internal combustion engine.

One possible approach to mastering the above-described operating characteristic of exhaust gas turbochargers is to provide an exhaust gas turbocharger with, for example, electrically driven additional units which may be engaged, for example, via a freewheeling clutch when the engine has reached a certain lower speed value and disengaged again after a certain speed of the engine, which prevents the turbo lag, has been exceeded; this may take place via a freewheeling clutch or an override clutch or the like.

Additional drives on exhaust gas turbochargers designed in this way on the one hand increase the cost of the exhaust gas turbocharger and on the other hand require a relatively large installation space, which is increasingly scarce on internal combustion engines.

The possible remedy presented above therefore represents a non-negligible cost regarding the components to be used and regarding the requirement of additional installation space in the engine compartment of an internal combustion engine.

Pulse superchargers are known from the related art. Pulse superchargers are situated in the intake tract of an internal combustion engine on the intake side of the engine. The pulse superchargers previously used function according to the flap principle and have a flap mechanism integrated into the charge air duct to the engine. The flap principle used, however, has the considerable disadvantage that the stability of the flaps is as unsatisfactory as it was previously due to the extremely short switching times and the frequent mechanical contact with stop surfaces. The frequent impact of the driven flaps of such pulse superchargers on the wall of the charge air duct on the one hand is accompanied by mechanical wear and on the other hand results in a non-negligible noise generated in the intake tract. The wear on the flaps of the utilized pulse superchargers associated with increasing operating time of the internal combustion engine on the other hand results in the flaps no longer being fully tight in the closed state and also in a leak air flow of the charge air, which increases over time, occurring along the no longer tightly closing flaps, which negatively affects the efficiency of a pulse supercharger thus designed in the intake tract of an internal combustion engine.

When the pulse superchargers used in the intake tract of an internal combustion engine are designed as rotary roller slides (e.g., in the form of a cylinder having e.g. a transverse bore hole), the pulse superchargers will need a relatively large installation space to cover the entire opening cross-section of the charge air duct. In addition to the large installed volume of pulse superchargers designed in this way, they have the disadvantage of a large moving masses, so that their use places considerable demands on the drive and on the other hand results in large mass moments of inertia. Short switching times are difficult to achieve with pulse superchargers designed as rotary roller slides.

### SUMMARY OF THE INVENTION

The exemplary embodiment and/or exemplary method of the present invention provides for a pulse supercharger, which may be used in the intake tract of an internal combustion engine, to be produced having a pair of rotary slide elements. The rotary slide elements may be driven via a drive unit, synchronized movement being achieved via a gear coupling of the two rotary slide elements. An electrical pulse coupling, for example, or also an electric motor may be considered as the drive unit. Instead of a pulse coupling, an eddy-current brake may also be used.

The advantages of using, for example, two rotary slide elements coupled to each other include, among other things, the fact that the surfaces of the rotary slide elements are insensitive to deposits. If the surfaces of the rotary slide elements exposed to the charge air flow have a curved design, a self-cleaning effect of the rotary slide elements is achieved, because the particulates contained in the charge air flow do not adhere to the surfaces of the rotary slide elements exposed to the charge air flow, but slide along these elements. Compared to a pulse supercharger which is designed as a rotary roller sluice slide, considerably lower rotational angles, for example, of only 45° may be achieved via the approach according to the exemplary embodiment and/or exemplary method of the present invention. The smaller the rotational angle can be held, the shorter switching times and higher switching frequencies may be achieved. The pulse supercharger according to the exemplary embodiment and/or exemplary method of the present invention has a two-part design, whereby two smaller units may be achieved for installation in a charge air duct in the intake tract of an engine. The two rotary slide elements, each forming a compact unit and cooperating with each other, have a considerably lower mass moment of inertia compared with the above-mentioned rotary roller slide, which is designed as a cylinder having a transversal bore.

The approach according to the exemplary embodiment and/or exemplary method of the present invention also has the advantage that in the opening position of the two cooperating rotary slide elements no hard stop against the wall of the charge air duct occurs, which substantially reduces the mechanical wear, which in turn considerably increases the stability of the pulse supercharger according to the exemplary embodiment and/or exemplary method of the present invention. Furthermore, even in the closed position, i.e., when the charge air duct is completely closed by the two adjoining rotary slide elements, no hard stop occurs, but rather the two rotary slide elements coupled together move over one another upon reaching their closed position and, in their position closing the charge air duct, assume an overlapping position. This may be achieved, for example, by offsetting the axes of rotation about which the two rotary slide elements coupled together are moved.

The approach according to the exemplary embodiment and/or exemplary method of the present invention may be combined with different drive concepts. An oscillating armature, the above-mentioned electric pulse coupling, or other drive concepts may be used for driving the rotary slide elements coupled together, the two rotary slide elements being coupled via a gear, independently of the drive. The drive is an electric motor, for example, which is associated with an oscillating armature. The oscillating armature is pre-stressed between two springs, so that the rotary slide elements may swing back with spring support.

Another advantage of the pulse supercharger according to the exemplary embodiment and/or exemplary method of the present invention is that it makes individual charge control of the individual cylinders of the engine, as well as an improvement in the charge dynamics to be achieved, possible compared to a conventional throttle device. In addition, the two rotary slide elements coupled together may be driven by two neighboring cylinders, for example, in the case of a four-cylinder, a six-cylinder, or an eight-cylinder engine using a shared actuator. Distribution to the individual cylinders does not take place until after the passage of the pulse supercharger.

### BRIEF DESCRIPTION OF THE DRAWINGS

FIG. 1 shows the intake tract and exhaust tract of an internal combustion engine having a pulse supercharger.

FIG. 2 shows a first embodiment of the pulse supercharger according to the exemplary embodiment and/or exemplary method of the present invention in the closed position.

FIG. 3 shows the pulse supercharger shown in FIG. 2 in the open position.

FIG. 4 shows another embodiment of the pulse supercharger according to the exemplary embodiment and/or exemplary method of the present invention in the open position.

FIG. 5 shows the embodiment of the pulse supercharger shown in FIG. 4 in the closed position in the charge air duct.

### DETAILED DESCRIPTION

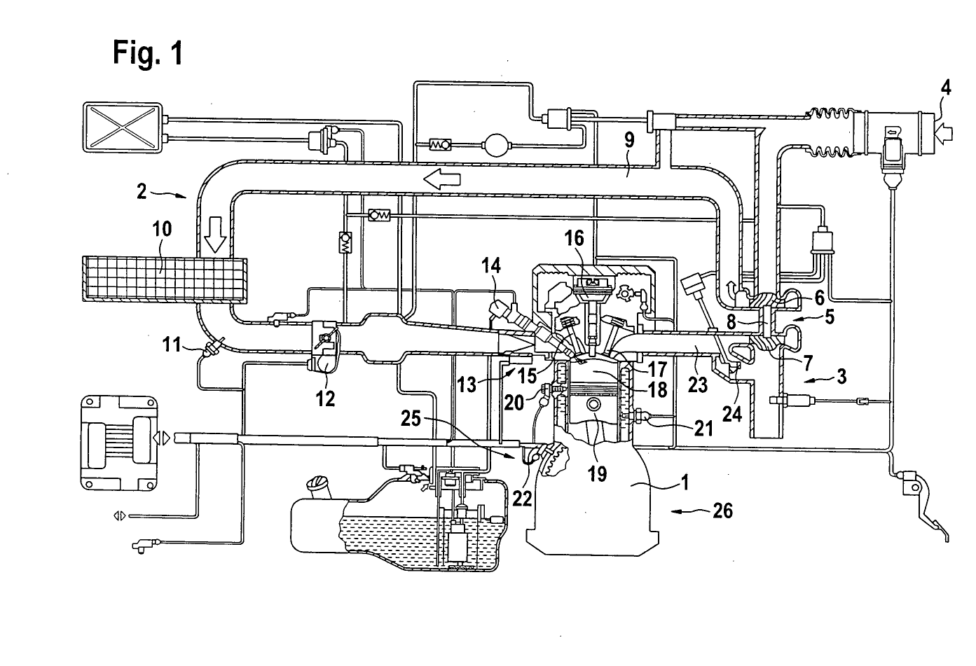

FIG. 1 shows an internal combustion engine and its intake tract and exhaust tract.

An engine 1 includes an intake tract 2 and an exhaust tract 3. The combustion air flows to the engine via an air intake 4, which may be provided with an air mass meter and usually contains an air filter element. The combustion air flows to a supercharger 5 which is situated on engine 1 and may be designed as an exhaust gas turbocharger or as a pressure wave supercharger. Supercharger 5 includes a compressor part 6 and a turbine part 7, compressor part 6 and turbine part 7 being connected via a shaft 8. Combustion air, which may be pre-compressed, flows via a charge air duct 9 to an intermediate cooler 10, which may be followed by a downstream charge air sensor 11. The air is metered to engine 1 via a throttle device 12 installed in charge air duct 9. According to FIG. 1, a pulse supercharger 13, which is known from the related art and works by the flap principle having the above-named disadvantages, is situated on intake side 25 of the engine. A fuel injector 14, via which fuel is injected into a combustion chamber 18 of engine 1 as soon as intake valve 15 is opened, is situated downstream from pulse supercharger 13. Reference numeral 17 denotes the exhaust valve on exhaust side 26 of engine 1. Externally ignited engines 1 also have an ignition device 16, whose ignition coil is reproduced only schematically in FIG. 1.

In addition, engine 1 includes at least one piston 19, which compresses the mixture contained in combustion chamber 18 and produces mechanical power after ignition.

In addition, a knock sensor 20, a temperature sensor 21, and an engine speed sensor 23 associated with the crankshaft are associated with engine 1.

On exhaust side 26, the exhaust gas flows from combustion chamber 18 via open exhaust valves 17 into an exhaust gas channel 23, which is connected to turbine part 7 of supercharger 5; a waste gate 24 may be provided in exhaust gas channel 23.

Pulse supercharger 13 schematically shown in FIG. 1 operates by the flap principle and has a relatively low stability.

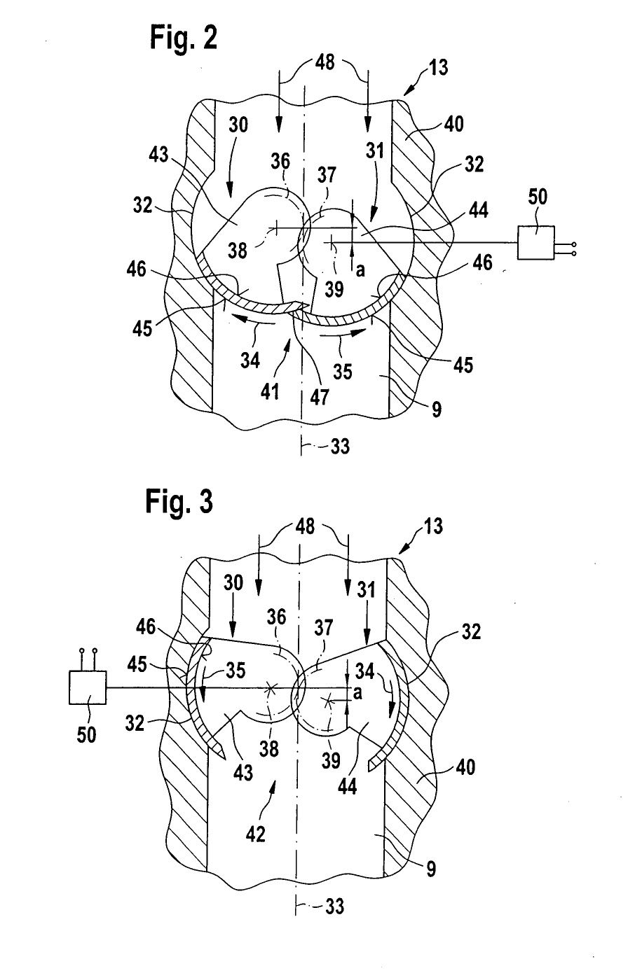

FIG. 2 shows a first embodiment of a pulse supercharger according to the exemplary embodiment and/or exemplary method of the present invention.

Pulse supercharger 13 is also situated in charge air duct 9 to intake side 25 of engine 1 and integrated into a wall 40 of charge air duct 9. Pockets 32 into which a first rotary slide element 30 and a second rotary slide element 31 may be moved are formed in wall 40. As depicted in FIG. 2, first rotary slide element 30 and second rotary slide element 31 are in their closed position 41. First and second rotary slide elements 30, 31 have webs 43, 44, on which, as shown in FIG. 2, surfaces closing in closed position 41 are formed at right angles. These have a curved design, so that the particulates contained in charge air flow 48 do not deposit on the surfaces closing charge air duct 9, but slide by on these surfaces.

First rotary slide element 30 and second rotary slide element 31 are rotatable about axes of rotation 38 and 39, respectively, and in the embodiment of FIG. 2 are mechanically coupled together via meshing tooth segments 36, 37. First axis of rotation 38 and second axis of rotation 39 are situated with respect to each other at an offset a, which allows the ends of first rotary slide element 30 and second rotary slide element 31 facing each other to overlap into their closed position 41 and prevents a hard impact of the two rotary slide elements 30, 31 against each other.

In closed position 41, a contact surface 47 is formed due to offset a of first axis of rotation 38 relative to second axis of rotation 39. The end of the surface perpendicular to web 44 overlaps the opposite end of the surface perpendicular to web 43 of first rotary slide element 30.

The two rotary slide elements 30 and 31 are arranged symmetrically to axis of symmetry 33 of charge air duct 9. The curved surfaces formed at right angles on webs 43 and 44 each an internal rotary slide surface 46 and in each case an external rotary slide surface 45. As depicted in FIG. 2, both rotary slide elements 30, 31 are in the closed position 41 and therefore have moved out of pockets 32 which are formed in wall 40 of charge air duct 9. However, in closed position 41, the curved closed position formed at right angles on webs 43 and 44 still dip into pockets 32 of channel wall 40. Due to the overlap between the external rotary slide element surface 45 with the surfaces of pockets 32, no leak flow of charge air 48 via rotary slide elements 30, 31 depicted in their closed position 41 is possible.

To open charge air duct 9, rotary slide elements 30 and 31, force-coupled via tooth segments 36, 37, are moved in the rotational direction 34, 35 shown by the arrows.

FIG. 3 shows the first embodiment of the pulse supercharger according to the exemplary embodiment and/or exemplary method of the present invention depicted in FIG. 2 in the open position. If rotary slide elements 30, 31 coupled together via tooth segments 36, 37 are moved into the open position 42 depicted in FIG. 3, the external rotary slide element surfaces denoted with reference number 45 move back into pockets 32 and open the flow cross-section of charge air duct 9. In open position 42, charge air 48 flows around webs 43, 44, so that the flow is barely hindered. Webs 43, 44 of the two coupled rotary slide elements 30, 31 are designed to achieve the desired mechanical stability while causing minimum impairment of charge air flow 48 through charge air flow duct 9. Due to the coupling of the two rotary slide elements 30, 31 via tooth segments 36, 37, the drive only drives one of the two rotary slide elements 30, 31.

FIG. 3 shows that, due to the curvature of the surfaces of pulse supercharger 13 formed perpendicularly on webs 43, 44, charge air flow 48 passes by curved inner rotary slide element surface 45 and no dead water zones are formed in which deposits might adhere, so that a self-cleaning effect of rotary slides 30, 31 of the pulse supercharger provided according to the exemplary embodiment and/or exemplary method of the present invention sets in.

The gas exchange to intake valve 15 of engine 1 is controlled using the embodiment of pulse supercharger 13 according to the exemplary embodiment and/or exemplary method of the present invention depicted in FIGS. 2 and 3. Due to the design of pulse supercharger 13 using two small rotary slide elements 30, 31, weak mass forces are achieved on the individual parts. The above-mentioned gear, which in the embodiment of FIGS. 2 and 3 is designed as two meshing tooth segments 36, 37, is suitable as a drive. As an alternative, a plurality of synchronously controlled drive units may be used, with each rotary slide element 30, 31 having a separate drive unit. In the supercharge mode of pulse supercharger 13, the point in time when opening is triggered is selected in such a way that the pulse coupling triggers considerably after the point in time when intake valve 15 of engine 1 opens. In the partial load range of the engine, the opening of rotary slide elements 30, 31 of pulse supercharger 13 is triggered very early, for example, even considerably before the point in time when intake valve 15 opens. This allows a closing of rotary slide elements 30, 31 to be achieved at a considerably earlier point in time, before intake valve 15 of engine 1 closes. This allows a load control which is optimized regarding throttle losses to be achieved. In addition, when the rotary slide elements are controlled separately, one of the rotary slide elements may be left in its closed position, whereas the other rotary slide element is open, so that turbulence may be achieved in the combustion chamber via the charge air flow thus conducted for better mixing of the combustion mixture. Throttle-free load control using the approach according to the exemplary embodiment and/or exemplary method of the present invention is achieved not only via intake valve 15, but already via upstream rotary slide elements 30, 31.

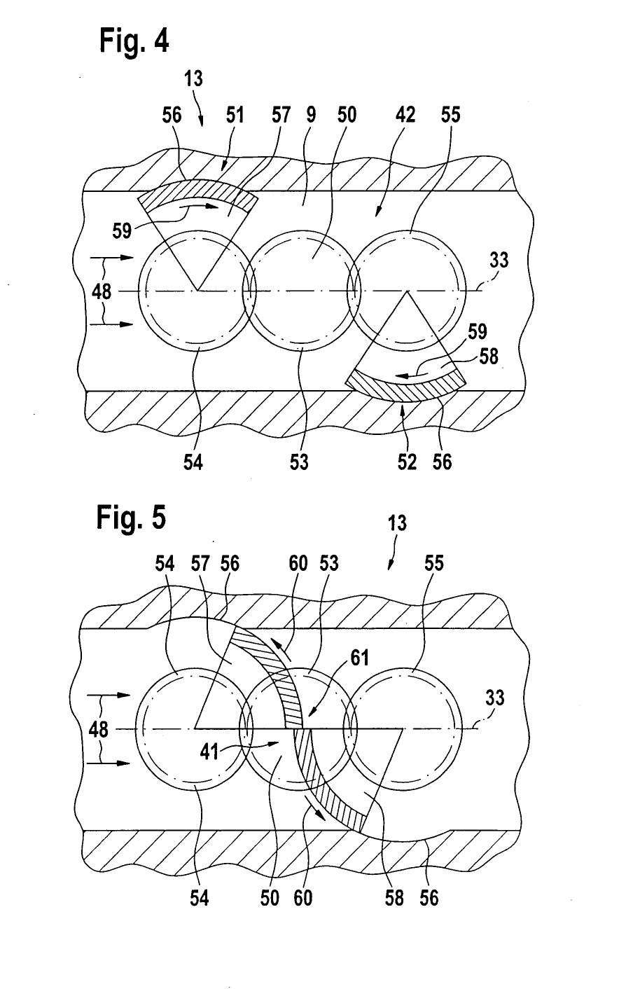

FIGS. 4 and 5 show another embodiment of the pulse supercharger according to the exemplary embodiment and/or exemplary method of the present invention in the intake tract of an engine.

In FIG. 4, pulse supercharger 13 includes a third rotary slide 51 and a fourth rotary slide 52, which are spaced with respect to the line of symmetry 33 in the axial direction, i.e., in the direction of charge air flow 48. In open position 42 of third rotary slide 51 and fourth rotary slide 52 depicted in FIG. 4, both rotary slides 51, 52 are returned into pockets 56, so that the flow cross-section of charge air duct 9 is open. Pockets 56 are located in channel wall 40 of charge air duct 9 and have a curvature which corresponds to the curvature of the outsides of the closing surfaces of third rotary slide 51 and fourth rotary slide 52 situated perpendicularly to webs 57 and 58.

Third rotary slide 51 and fourth rotary slide 52 are connected non-rotatably to a first gear 54 and a second gear 55. The two gears 54, 55 are moved in opposite directions via a drive wheel 53 of a drive 50. The rotational direction in which the third rotary slide 51 and the fourth rotary slide 52 are moved from their open position 42 into their closed position 41 shown in FIG. 5 is indicated by arrow 59. In the embodiment of the pulse supercharger according to the exemplary embodiment and/or exemplary method of the present invention depicted in FIG. 4, third rotary slide 51 and fourth rotary slide 52 are force-coupled to drive 50 via gears 54, 55 in such a way that it is ensured that third rotary slide 51 and fourth rotary slide 52 are moved synchronously. Similarly to the first embodiment of pulse supercharger 13 according to the exemplary embodiment and/or exemplary method of the present invention and depicted in FIGS. 2 and 3, the surfaces closing or opening the flow cross-section of charge air duct 9 are perpendicular to webs 58, 59. Also in this embodiment, the closing surfaces of third rotary slide 51 and fourth rotary slide 52, situated perpendicularly to webs 57, 58, have a curved design, so that the particulates contained in charge air flow 48 cannot deposit on the surfaces.

FIG. 5 shows the rotary slide elements moved from their open position according to FIG. 4 into their closed position according to the second embodiment.

If third and fourth rotary slide elements 51, 52 returned into pockets 56 are moved into their closed position 41 in rotational direction 59, third rotary slide element 51 and fourth rotary slide element 52 move synchronously out of pockets 56. In closed position 41, the ends of third rotary slide element 51 and fourth rotary slide element 52 facing one another overlap and form an overlapping 61. At the same time, however, the rear section of both rotary slide elements 51, 52 moved into their closed position still partially overlap with curved pockets 56 in wall 40 of charge air duct 9. This prevents leakage of charge air flow 48, i.e., undesirable passage of charge air through pulse supercharger 13 in closed position 41.

Rotary slide elements 51 and 52 depicted in the second embodiment also represent two separate compact inserts, which allow a relatively low mass moment of inertia to be achieved. This is advantageous regarding short switching times and high triggering frequencies. In addition, using slide elements 51, 52 depicted in open position 42 and closed position 41 in FIGS. 4 and 5, respectively, a relatively low angle of rotation of <45° is achievable, which also represents an advantage regarding shorter switching times and higher triggering frequencies when pulse supercharger 13 in charge air duct 9 to intake side 25 of engine 1 is operated.

Using pulse supercharger 13 depicted in FIGS. 2 and 3 in a first embodiment and in FIGS. 4 and 5 in a second embodiment, neighboring cylinders of a four-, six-, or eight-cylinder engine may also be operated using a shared actuator and shared rotary slides.

The cylinder-individual charge control of the individual cylinders of a multicylinder engine is not distributed until charge air flow 48 has passed pulse supercharger 13. Charge air flow 48 may also flow in the direction opposite to the one depicted in FIGS. 2 and 3, or FIGS. 4 and 5 with respect to rotary slide elements 30, 31.

### THE LIST OF REFERENCE NUMERALS IS AS FOLLOWS

1 internal combustion engine
2 intake tract
3 exhaust tract
4 air intake
5 supercharger
6 compressor part
7 turbine part
8 shaft
9 charge air duct
10 intermediate cooler
11 charge air sensor
12 throttle device
13 pulse supercharger
14 fuel injector
15 intake valve
16 ignition device
17 exhaust valve
18 combustion chamber
19 piston
20 knock sensor
21 temperature sensor
22 engine speed sensor
23 exhaust gas channel
24 waste gate
25 engine intake side
26 engine exhaust side
30 first rotary slide element
31 second rotary slide element
32 pocket
33 axis of symmetry of charge air duct 9
34 first rotational direction
35 second rotational direction
36 first tooth segment
37 second tooth segment
38 first axis of rotation
39 second axis of rotation
40 wall
41 closed position
42 open position
43 first web
44 second web
45 external rotary slide element surface
46 internal rotary slide element surface
47 contact surface in closed position 41
48 charge air flow
50 drive
51 third rotary slide element
52 fourth rotary slide element
53 drive wheel
54 first gear
55 second gear
56 pocket
57 first web
58 second web
59 rotational direction in the direction of closing
60 rotational direction in the direction of opening
61 overlapping in closed position 41, and
a offset of axes of rotation 38, 39.

1-12. (canceled)

13. A pulse supercharger for an internal combustion engine, comprising:
a pulse supercharger arrangement, which is for situation in a charge air duct in which opening or closing a flow cross section of the charge air duct provides a charge air flow, the pulse supercharger arrangement including two synchronously operatable rotary slide elements.

14. The pulse supercharger of claim 13, wherein the rotary slide elements include surface sections which have a curved shape.

15. The pulse supercharger of claim 14, wherein the surface sections are attached to swivelable webs which extend parallel to a flow direction of the charge air flow.

16. The pulse supercharger of claim 13, wherein the rotary slide elements are returned into pockets of a wall of the charge air duct in their open position.

17. The pulse supercharger of claim 13, wherein the pockets have a curved outline which corresponds to an outside curvature of surface sections.

18. The pulse supercharger of claim 13, wherein the rotary slide elements are swivelable about axes of rotation, which are oriented perpendicularly to a flow direction of the charge air flow.

19. The pulse supercharger of claim 13, wherein a first rotary slide element is coupled to a second rotary slide element via tooth segments.

20. The pulse supercharger of claim 13, further comprising:
a third rotary slide element and a fourth rotary slide element, which are coupled to a shared drive via gears.

21. The pulse supercharger of claim 13, wherein the rotary slide elements are each driven by a separate drive, wherein one of the rotary slide elements remains in a closed position and a respective other one of the rotary slide elements assumes its open position.

22. The pulse supercharger of claim 13, wherein in a closed position, one of the following is satisfied: (i) ends of the rotary slide elements face an axis of symmetry of the charge air duct overlap; and (ii) the ends of the rotary slide elements facing one another overlap asymmetrically with respect to the axis of symmetry of the charge air duct.

23. The pulse supercharger of claim 18, wherein the axes of rotation are offset relative to each other by an offset a.

24. The pulse supercharger of claim 13, wherein the ends of the surfaces of the rotary slide elements facing pockets overlap with the pockets in the closed position.
